(19) United States
(12) Patent Application Publication
(10) Pub. No.: US 2002/0112245 A1
(43) Pub. Date: Aug. 15, 2002

(54) Method and device for administrating information in an interactive communication system

(76) Inventors: Jean-Claude Sarfati, Epinay (FR); Eric Delaunay, Paris (FR); Abdellah El Omari, Dreux (FR)

Correspondence Address: Rosenthal & Osha L.L.P., Suite 2800, 1221 McKinney, Houston, TX, 77010, US

(21) Appl. No.: 10/038,859

(22) Filed: Jan. 3, 2002

(30) Foreign Application Priority Data
Jan. 3, 2001 (FR) 01 00037

(51) Int. Cl. H04N 7/173

(52) U.S. Cl. 725/93; 725/92; 725/86

(57) ABSTRACT

The invention concerns a method for administrating information in a system for interactive communication comprising :

a) following a request for information (106) the verification (102, 104) if said information is available in the cache memory, the loading (110) of the information from the cache memory when it is available, and the loading of the information from a broadcast source when it is unavailable,

b) and further comprising the association (114) to the information in the cache memory of validity data, the verification of the validity data, in response to the request of information, and the loading of the information from the broadcast source when the validity data of the information available in cache memory is expired.

Use for interactive applications.

### TECHNICAL FIELD

The present invention relates to a method and a device for administrating information in an interactive communication system.

An interactive communication system is understood to be any system for exchanging data between at least a broadcast center and a user, in which the user has the possibility of choosing among a diversity of information that is made available to him by the broadcast center.

The typical field of application of the invention, where such an exchange occurs, is the digital broadcast of televisual programs, or the broadcast of other services provided by a supplier to a certain number of subscribers.

The services discussed herein may be very variable. For example they may comprise, as indicated herein above, television programs, but also magazine pages, video games, overviews of services offered to the user, calendars, or any other information. All these services, with the exception of video and audio broadcast, are hereafter referred to as “interactive applications”.

### STATE OF THE PRIOR ART

Before looking at the state of the art relating to the field of the invention, it is appropriate to more explicitly state the meaning of the term “information” used all along of the description. The term information equally refers to two types of data broadcast to the user. The first type of data comprises simple data, i.e., data capable of transporting pictures, sound or messages. These pictures or messages may be displayed on a television, or on a screen coupled to a receiver and information processing device, commonly referred to as “decoder”, which the user is equipped with. The second type of data comprises program data, which is software data allowing the information processing device to perform a certain number of operations. These operations may comprise among others the processing of simple data.

The broadcast of information from a broadcast center to the user is generally done by way of Hertz waves and by means of a television broadcast satellite. It may also be done by means of a cable network or by digital Hertz waves. The information is broadcast in packets.

The satellites are featured with a plurality of transponders each allowing to transmit packets of information. However, the amount of information that the transponders allow to broadcast is limited by the bandwidth allocated to the broadcast by Hertz waves.

Hence, in order not to restrict the flow of available information to the physical boundaries of the bandwidth, the information is multiplexed and, some of it rather then being broadcast in a continuous way is broadcast in a cyclical way according to cycles of variable length. This is notably the case for information concerning the interactive applications. Depending on the content or the type of information considered, the broadcast cycle of the information packets may be more or less long. It may vary, for example, from 100 msec for information with rapid recurrence, to 20 sec, or even much more, for information with slow recurrence.

At the user's command for downloading a determined information, or at the request for downloading an information which result from the execution of an interactive application program in the user's processing device, it is necessary to wait for the next broadcast cycle of the desired information, before proceeding to its processing or its display.

This waiting, which is variable according to the broadcast cycle of the desired information, may reveal to be uncomfortable for the user and may possibly be interpreted as a dysfunction of the processing device.

In order to improve the availability of the information, it is known to outfit the processing device with a memory in which a certain amount of information may be stored. This way, following a request for information from the user or from the interactive application being executed, it is possible to extract the information from the memory in which it is immediately available, without waiting for a next broadcast cycle.

This solution allows, in a broad manner, to avoid untimely waiting periods.

However a new drawback occurs. It is the drawback of outdated stored information. An information stored in the memory at the time of its first download might indeed be outdated at the time of a next use, when it is loaded from the memory. For example, an information concerning a program guide of broadcast television programs becomes outdated immediately after the broadcast took place.

A solution to this problem would be, for example, to continuously update the content of the memory. It is therefore appropriate to check if all the information stored is still valid or not. This may be done, for example, by comparing the information stored in memory with new broadcast information. And to update it if necessary.

It appears that this monitoring of stored information and its continuous updating requires a thorough equipment in the device of the user. In particular, the updating of the information requires thorough and expensive demultiplexing and filtering means. Furthermore, the existing decoders would not be suitable to execute such a task.

An illustration of the technology and of the difficulties mentioned here above is given for example by the document (1) the complete reference of which is given at the end of the specification.

### SUMMARY OF THE INVENTION

It is the object of the present invention to provide an information administration method in an interactive communication system which does not have the above mentioned limitations.

One object in particular is not to increase the number of filters and components required for receiving information flows.

Another object is to reduce at a minimum the waiting time at the execution of an interactive application, and to increase the comfort of use of the processing device.

Also another object is to provide a method allowing to guarantee at any time the validity of available information.

Finally it is an object of the invention to provide a communication device allowing to implement the method.

In order to achieve these objects, the invention more precisely concerns a method for administrating information in an interactive communication system comprising

a) following a request for information from a user or resulting from the execution of a program, the verification if said information is available in a memory called cache memory, the loading of the information from the cache memory when it is available, and the loading of the information from a broadcast source when it is not available in the cache memory, and further comprising :

b) the associating to a least a part of the information of the cache memory of date or duration or validity date data, the verification of the duration of validity of an information contained in the cache memory, in response to the request for said information, and the loading of the information from the broadcast source if the duration, or the date of validity of the information available in the cache memory have expired.

By attributing a duration of validity data to the information, it is possible to leave out the updating of the cache memory content, without risking to use an outdated information. Indeed if it turned out that at the moment when the loading of an information is requested the duration or the date of validity of this information, stored in cache memory, were outdated or expired, the information would not be loaded from he cache memory but would be subject to a new loading from the broadcast source.

The new information providing from the broadcast source may also, in this case, be recorded in the cache memory. The same principle may also be applied too record any new information that is unavailable in the cache memory at the moment where it is requested.

The duration or the date of validity that are assigned to an information, preferably at its recording in memory, may be fixed in different ways. The simplest way would consist in fixing in an arbitrary manner the duration of validity to a predetermined value independent from the type and the content of the information. However this solution is risky because if the arbitrary duration of validity is relatively long, it may possibly exceed the real duration of validity of the information. This restricts the choice of the duration of validity to very short values.

Another possibility, which allows to avoid this risk, consists in choosing the duration of validity of an information depending from the type of information being considered.

As an example, for information of simple data or information for which short broadcast cycles are available, it is possible to use a brief duration of validity.

On the other hand, for information of the program data (software) type a long or possibly infinite duration of validity may be attributed. An information with infinite duration of validity will only be deleted from the memory when the maximum capacity of this memory is reached. The renewal of the information stored may then be of the “first in, first out” type.

A third possibility for assigning the duration or the date of validity consists in fixing this duration or date depending from the content itself of the considered information. As a way of illustration, a simple data information concerning the program date and time of a television program, becomes obsolete once this date and this time are expired. The validity data may therefor take into account, for example, this date and this time as limit of expiration.

The information may also be put into memory, particularly in the form of tables or sections in the MPEG norm (Moving Picture Experts Group, norm for the broadcast of animated pictures). In this case, duration of validity data may be associated, for example, to every table or section. The validity data may be in form of a date or time stamp for the limit of validity. In this case, the verification of the expiry for the validity data consists, for example, in the simple comparison of the date or the time stamp with the actual date or time indication given by a clock.

According to a particular embodiment of the method of the invention, an identifier may be associated to every information of the cache memory. The identifier allows an easier ulterior search of this information in the memory.

The identifier may be data linked to the content of the information, in the form of, for example, a signature made from different components of the information.

In the particular case where the information is in the form of MPEG tables, the identifier may be a signature coded in 16 bits and designed by MD5. This signature is representative of the content of a data table of a program executable in the processing device of the user. The same signature may also be used for the identification of simple data information associated to programs and to be used for the execution of the latter.

The invention also relates to an interactive communication device, comprising:

an information processing unit,

a system for downloading information from a broadcast source, in response to a command from the processing unit,

at least an additional memory (cache) for receiving the information, for their storage in association with a duration of validity data,

a system for administrating the memory in order to load, in response to a command from the processing unit, information from the additional memory when this information, having a non-expired validity data, is present in the additional memory (cache).

The command from the processing unit as indicated herein above may be a command resulting from the execution of a program or a command resulting of a user's choice transmitted to the processing unit.

The information providing from the additional memory may be loaded directly in the processing unit or possibly transit through a buffer memory.

Other features and advantages of the invention will become apparent from the following description referring to the figures of appended drawings. This description is given as purely illustrative and non restrictive.

### BRIEF DESCRIPTION OF THE FIGURES

FIG. 1 is a very schematic and simplified illustration of a communication system using a device according to the invention. For reasons of clarity, the different parts of FIG. 1 are not represented according to a uniform scale.

FIG. 2 is a flow chart showing possible steps of an information administrating method according to the invention.

### DETAILED DESCRIPTION OF EMBODIMENTS FOR THE INVENTION

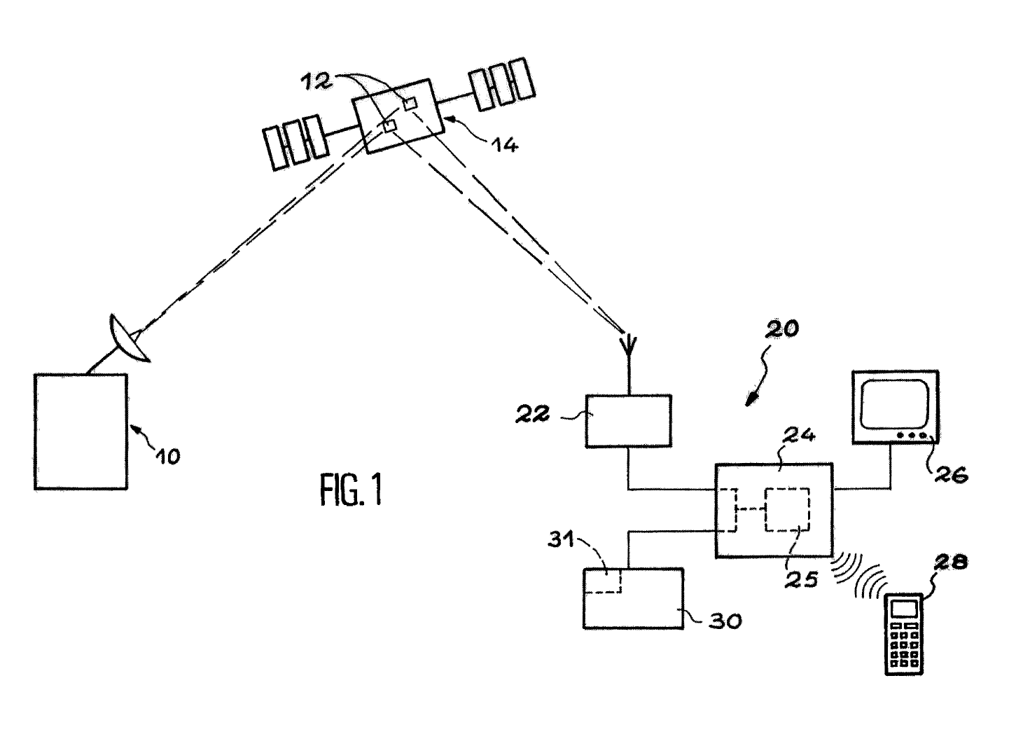

The reference 10 in FIG. 1 indicates in a general manner a digital broadcast center. This broadcast center emits, by means of Hertz waves, by electrical cable, or optical, a certain amount of information. Among these may be found audio information, video information and other information linked to interactive application (games, newsbulletin, TV program etc.). As previously stated the information is multiplexed and emitted in a cyclical manner in packets of information. In the example of the figure, the information is retransmitted to a large number of potential users by way of transponders 12 of a satellite 14.

The users are equipped with devices for receiving and processing information, as indicated with the general reference 20.

The device 20 shown in FIG. 1 comprises a certain number of means 22 allowing to receive the information transmitted from the broadcast center 10. These means notably have an antenna, a demodulator, and filters for selecting a multiplexing channel of one or many transponders. A processing unit 24, having a buffer memory 25, may receive information in form of data for programs to execute or in form of simple data, used in the frame of program execution, for rendering pictures and sound. A television 26 connected to the processing unit symbolically represents a means for rendering pictures and sound.

A command given by a user which activates a command interface 28, or a command resulting from the execution of a program of an interactive application by the processing unit, allows to trigger the loading of new information in the buffer memory 25.

This information may provide from two distinct sources: either a memory 30, called cache memory, or means 22 for receiving information broadcast for television.

A system for administrating the cache memory, basically indicated at the reference 31, allows to affect to each information stored in memory a data for the duration of validity according to the previously explained principle. The system for administrating the cache memory, represented separately here for reasons of clarity, may, of course, be part of the processing unit.

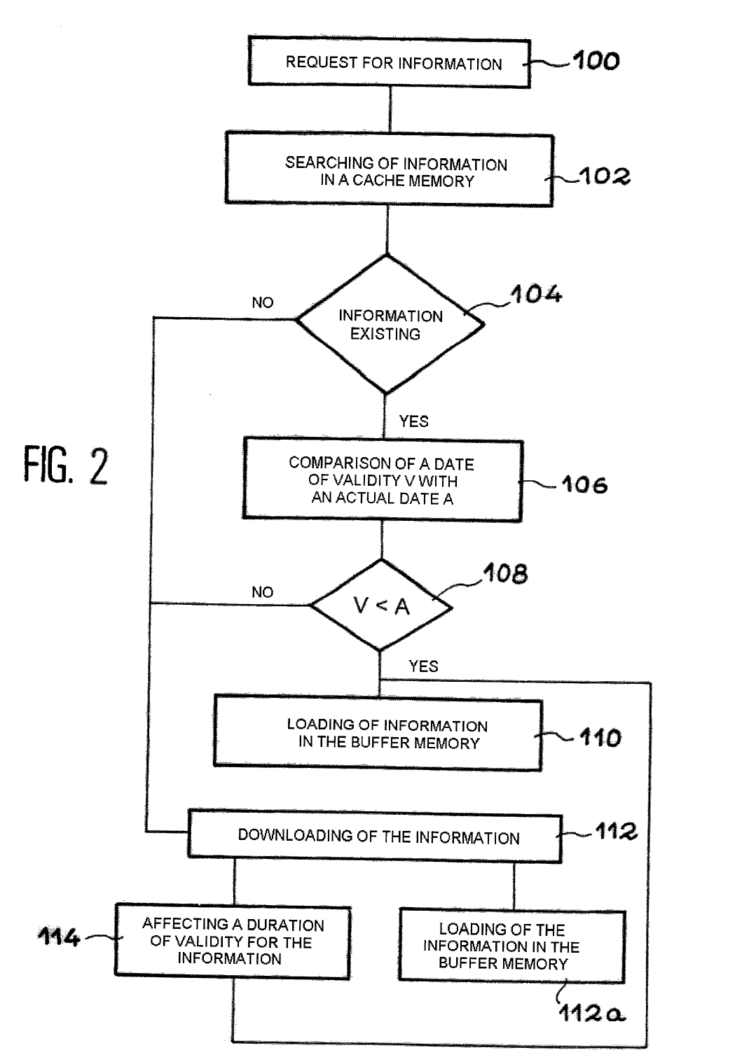

The method for administrating information by the device 20 is explicated in the FIG. 2.

A first step 100 corresponds to the request for information. This is required, has indicated herein above, by the processing unit in response to an executed program, or in response to a request from the user.

A step for searching information 102 is then performed by the system for administrating the memory in order to identify the information in the cache memory 30. A step of deciding 104 depends from the search result. If the searched information is found in the memory, then a comparison is performed in a step 106 between data indicating a validity or a date of validity of the information considered and an actual date provided by a clock. By “date” it is to be understood any temporal print given in any time unit. The comparison of the date of validity and the actual date gives rise to a second step of deciding 108.

When the data of validity is recognized as not yet being expired, the information is loaded into the buffer memory of the processing unit and used for the processing of data or for their display. This corresponds to step 110.

If during one of the steps of deciding 104 or 108 it is found that the searched information cannot be found in the cache memory or if it is obsolete, the information is obtained by downloading. The downloading corresponds to step 112.

It is obvious that, in this particular case, a possible delay might affect the function of the device, since the next broadcast cycle of the desired information must possibly be waited for during some time. This waiting however only occurs at the first loading or when two subsequent requests for the same information are separated in time by a period which exceeds the duration of validity. This situation seldom occurs since a user often selects the same information, according to his usual choice of offered interactive applications, or according to his habits. Furthermore, the waiting experienced by the user may be reduced if short lifetimes for information are affected to information which also have a short cycle of recurrence.

The downloading allows, on one hand, to put the information in the buffer memory, and, on the other hand, to store it in the cache memory.

Once store in the cache memory, the information may be removed from the buffer memory.

For reasons of clarity, the loading of information in the buffer memory is indicated separately using reference 112a. It is however concomitant to the downloading.

The loading of the same information in the cache memory, is preceded by a preliminary step 114 of affecting a date or a duration of validity.

As previously indicated, the information may be found using an identifier which is representative of the content of the information. In this case, a new information, which has not been found in the cache memory, or for which the data of date or duration of validity differs from the one of an information present in the cache memory, receives a new identifier and may therefore not be mistaken with an obsolete information remaining in the memory. An information which is found to be obsolete may hence be deleted from memory during the step of comparison 106, or remain there until an automatic removing according to the already mentioned principle of first in, first out.

If all the obsolete information has already been removed, it is also possible if necessary to remove information which is still valid. In this case the removed information is the oldest, always according to the principle of the first in-first out.

When a data information is associated to a program information, for example, an interactive application, it is possible to use, for the data information, an identifier depending from the one used for the corresponding program information. For example, the “signature” of a program information may be used to find in the cache memory the corresponding data information. This is, in general, a way of simplifying the future search of information in the memory.

Cited Document

(1)

EP-A-0823 798

1. Method to administrating information in an interactive communication system comprising:
a) following a request for information (106) from a user or resulting from the execution of a program,
The verification (102, 104) if said information is available in a memory called cache memory,
The loading (110) of the information from the cache memory when it is available, and
the loading of the information from a broadcast source when it is not available in the cache memory,
b) and further comprising
the associating (114) to at least a part of the information of the cache memory of date or duration or validity date data,
the verification of the duration of validity of an information contained in the cache memory, in response to the request for said information, and
the loading of the information from the broadcast source if the validity data of the information available in the cache memory is expired.

2. Method according to the claim 1, further comprising, following the request for information from the user, the storing in memory of said information loaded from the broadcast source, when it is initially unavailable in the memory.

3. Method according to the claim 1, in which the validity data is affected to the information at its storing.

4. Method according to the claim 1, in which validity data is affected to the information depending on the content of said information.

5. Method according to claim 1, in which validity data is affected to the information depending on the type of information to which the information corresponds.

6. Method according to the claim 1, in which arbitrary predetermined validity data is affected to the information.

7. Method according to the claim 1, in which an identifier is affected to each information in the cache memory.

8. Method according to the claim 7, in which the identifier of the information depends from the content of the information.

9. Method according to the claim 7, for the administration of data information associated to program information, in which an identifier is affected to a data information, which depends from the indentifier affected to an associated program information.

10. Method according to the claim 1, in which the information is stored in memory in form of tables or MPEG sections.

11. Device for interactive communication comprising :
a unit (23) for processing information,
a system (10, 14, 22) for downloading information from a broadcast source, in response to a command from the processing unit,
at least an additional memory (30) (cache) for receiving information, for their storage in association with a duration of validity data,
a system for administrating the memory in order to load, in response to a command from the processing unit, information from the additional memory, when this information, having a non-expired validity data, is present in the additional memory.
